(19) United States
(12) Patent Application Publication
(10) Pub. No.: US 2010/0101438 A1
(43) Pub. Date: Apr. 29, 2010

(54) APPARATUS AND METHOD FOR ADJUSTING GAP BETWEEN CREASING ROLLER OF PRINTING PRESS, AND PRINTING PRESS

(75) Inventors: Kunihiro Shichijo, Hiroshima-ken (JP); Shinichiro Senoo, Hiroshima-ken (JP)

Correspondence Address: KANESAKA BERNER AND PARTNERS LLP, 1700 DIAGONAL RD, SUITE 310, ALEXANDRIA, VA, 22314-2848, US

(73) Assignee: Mitsubishi Heavy Industries, Ltd., Tokyo (JP)

(21) Appl. No.: 12/449,253

(22) PCT Filed: Feb. 14, 2008
(86) PCT No.: PCT/JP2008/052460

§ 371 Date: Sep. 3, 2009

(30) Foreign Application Priority Data
Feb. 14, 2007 (JP) 2007-033664
Feb. 28, 2007 (JP) 2007-050020

(51) Int. Cl. B41F 13/24

(52) U.S. Cl. 101/248

(57) ABSTRACT

An apparatus and a method for adjusting a gap between folding rollers to fold signature in a printing press and the printing press are disclosed. To automatically adjust the gap to the optimum distance through which signatures are passing, the apparatus includes gap adjusting mechanism 17 for adjusting the gap between a pair of folding rollers 14 and 14 to press and fold signature 1, detecting unit 23 for detecting transfer state information relative to actually passing the printed sheets through the gap between the pair of the folding rollers; and controller 24 for controlling the gap adjusting mechanism so that the gap between the folding rollers corresponds to the transfer state information detected by the detecting unit.

### TECHNICAL FIELD

The present invention relates to an apparatus and a method for adjusting a gap between a pair of folding rollers which press and fold a signature formed by cutting print sheet (s) undergone printing and which is included in a printing press, such as an offset rotary press, and a printing press including the apparatus for adjusting the gap.

### BACKGROUND OF THE INVENTION

In a general printing press such as an offset rotary press uses a continuous paper sheet (web) fed from a feeder as a print sheet, which undergoes printing in a print section and then is longitudinally folded (i.e., folded in the transfer direction) by a former of a folder and cut into a signature. The signature is cross-folded (in the direction perpendicular to the transfer direction) by a folding cylinder, longitudinally folded (chopper-folded) by a chopper and then pressed by a pair of chopper rollers to process the fold. Finally, the signature is ejected by a delivery unit using an impeller or the like.

The folder of a rotary press is formed by a former (triangle former), a folding cylinder, a saw cylinder, and a pair of folding-down dragging rollers which are sequentially arranged from the upstream. After the former longitudinally folds a web (i.e., along the longitudinal direction), the web is cut by the folding cylinder and the saw cylinder, and folded in the cross-folding direction (i.e., along the direction of the cutting) by a folding blade of the folding cylinder. The fold is pressed by the folding-down dragging rollers and the web is successively sent out to the impeller and conveyer arranged downstream of the folder.

Both above chopper rollers and folding-down dragging rollers have a common function as folding rollers (also called nipping rollers or folding-into rollers) which press signatures to fold.

Such folding rollers will now be detailed using the above chopper which chopper-fold signatures as an example. As shown by an example of FIG. 9, signature 1 transferred on transfer belt 11 from the upstream is folded into slit 12a on chopper table 12 by chopper blade 13 which is arranged above slit 12a and which moves upwards and downwards. The folded-into signature 1a is drawn into between a pair of chopper rollers (folding rollers) 14 and 14 arranged below chopper table 12 through slit 12a to pass through the gap between chopper rollers 14 and 14, and is sent out to be delivery unit (not shown) arranged below the rollers 14 and 14.

For operation of the printing press, such chopper rollers require the gap therebetween to be adjusted to a proper distance (gap) according to the thickness of a printed sheet to undergo printing. In other words, an excessively wide gap between chopper rollers 14 and 14 cannot sufficiently fold signature 1a, and an excessively narrow gap between chopper rollers 14 and 14 cannot smoothly pass through signature 1a, which cause damage to signature and troubles in transferring signature 1a.

To solve the problems, the chopper device is able to adjust the gap d between the chopper rollers 14 and 14 as shown in FIG. 10. In the structure shown in FIG. 10, each of rollers 14 and 14 is rotatably supported by first end (the upper end) 15a of supporting arm 15 swingably pivots around supporting axis 16. The gap between rollers 14 and 14 is widened by making the second ends (the lower ends) 15b of supporting arms 15 closer to each other, and the gap is narrowed by departing the second ends 15b of supporting arm 15 from each other.

The chopper further includes gap adjusting mechanism 17 to restrict first ends 15a of supporting arms 15 to come close to each other, allowing the end 15a to depart from each other. In this example, gap adjusting mechanism 17 includes spring 18 arranged between the second ends 15b of supporting arms 15, movable stopper members 19 each of which is arranged on the outside of the second end 15b of one of supporting arms 15 and screw axis 20 for adjusting the positions of stopper members 19.

Spring 18 forces second ends 15b of supporting arms 15 in such a direction that arms 15 depart from each other. Stopper member 19 of each second end 15b of each supporting arm 15 contacts the corresponding second end 15b to restrict, by the force spring 18 applies, each second end 15b of supporting arms 15 to depart from each other. Consequently, each second end 15b of supporting arms 15 is able to come close to each other against the force applied by spring 18, but the movement of second ends 15b of arms 15 in the direction of departing from each other is limited by stoppers 19. Focusing on the gap between rollers 14 and 14, rollers 14 and 14 are limited to coming closer to each other than the gap determined by stopper members 19, so that the rollers 14 and 14 are allowed to depart from each other.

In the illustrated example, a ring-shaped portion is formed on second end 15b of each of supporting arms 15 in which portion stopper member 19 is incorporated. Each of stopper members 19 includes contacting face 19c in contact with the outward face of second end 15b and screw thread 19a or 19b. Revolution of stopper member 19 is restricted by non-illustrated revolution limitation mechanism.

On the outer circumference surface of screw axis 20, first external threads 20a and 20b are formed at a predetermined distance. One (here, external thread 20a) of external threads 20a and 20b is a right hand thread, and the other (here, external thread 20b) is a left hand thread. In the meanwhile, screw thread 19a of one stopper member 19 is a right hand thread to fit right-hand external thread 20a, and second screw thread 19b of the other stopper member 19 is a left hand screw to fit left-hand external thread 20b. In addition, handle 21 is formed on one end (the right end in the drawing) of screw axis 20 to rotate screw axis 20.

With this configuration, when handle 21 is turned to rotate screw axis 20 rightwards as viewed from the right side in FIG. 10, stopper member 19 with right-hand screw thread 19a moves right and stopper member 19 with left-hand screw thread 19b moves left. Namely, both stopper members 19 and 19 come close to each other. Conversely, rotation of screw axis 20 leftwards as viewed from the right side in FIG. 10 causes both stopper members 19 and 19 to depart from each other.

It is therefore possible to adjust the gap between rollers 14 and 14 to be in a proper state by hand operation on handle 21.

Gap adjusting mechanism 17 using such “screw axis” is mounted in each of axis ends of chopper rollers 14 and 14. A hand operation on each gap adjusting mechanism 17 carries out gap adjustment on the corresponding chopper roller 14.

If the above folding-down dragging rollers are used, mechanisms similar to gap adjusting mechanism 17 is equipped.

However, since such technique rotates the screw axis with a handle by hand in order to adjust the gap between rollers, it requires labor and time to vary the thickness of a printed sheet. Further, the above hand operation has to be carried out each time the thickness of a printed sheet varies, increasing operator's labor.

In particular, operation on the handle by hand is carried out on each individual chopper roller, which makes it difficult to grasp the amount of movement of each side of the screw axis and consequently makes it difficult to obtain the parallelism between the chopper rollers. But, in this case, perfect parallelism is not always preferable. Substantial parallelism in which the rollers form a minute angle is preferable in some cases.

If the chopper rollers do not obtain parallelism, signature may get jammed or come toward to either side between the rollers, increasing the amount of paper loss. As a solution to the problem, a certain level of parallelism has to be obtained even though it takes a long time, which increases the load of the operator and the variation time. An increase in the variation time results in decline in work efficiency of the printing press.

Concerning the problem, there are proposed automatic adjustments of the gap between folding rollers as disclosed in, for example, Patent References 1-3.

Patent Reference 1 discloses a technique in which the screw axis of the gap adjusting mechanism can be driven by driving means such as a motor, and control means controls the driving means on the basis of the relationship between a thickness of a printed sheet to pass through between rollers and a proper gap between rollers to automatically adjust the gap, so that load of the operator and time when the thickness of the paper sheet varies can be greatly reduced.

In the technique disclosed in Patent Reference 2, the screw axis of gap adjusting mechanism for folding-down dragging rollers is driven by driving means such as a motor, and control means obtains a proper gap between the rollers according to paper data concerning the thickness and the physical properties of a cut paper which has been folded in two and which is to pass through between rollers and an operation speed of the rotary press, and the driving means is controlled such that the gap is adjusted to the proper gap between rollers. Consequently, such automatic gap adjustment greatly reduces the load of the operator and time to vary the thickness of the paper sheet.

Patent Reference 3 sets a target value for the gap between folding rollers on the basis of paper quality, paper thickness, the number of folding and a variation in the print speed, and adjusts the gap to the target value with a motor. In other words, paper quality, paper thickness, and the number of folding are determined previously and the print speed is varied in accordance with the printing speed in this technique.

[Patent Reference 1] Japanese Patent Application Laid-Open (KOKAI) No. HEI 7-237812

[Patent Reference 2] Japanese Patent Application Laid-Open (KOKAI) No. 2006-312497

[Patent Reference 3] Japanese Patent Application Laid-Open (KOKAI) No. 2005-219831

### DISCLOSURE OF THE INVENTION

### Problems to be Solved by Invention

In the techniques of automatically adjusting the gap as disclosed in Patent References 1 and 2, although it is sure that the load on the operator and the time required for the variation can be reduced enhancing reduction in time for operation. These techniques require heavy burden on the preparing time and the preparing cost. That is, these techniques require preparation of a database obtained through a large number of experiments in advance which database concerns the relationship between the thickness of a print paper passing through the gap between the rollers and the proper distance of the gap (for Patent Reference 1) or a proper roller gap corresponding to paper data concerning the thickness and the physical properties of a cut paper which has been folded in two and which is to pass through between rollers and an operation speed of the rotary press (for Patent Reference 2). The preparation results in increase in time and costs.

A printed sheet actually passing through the gap between two rollers is folded in two or more, so it is difficult to estimate the optimum gap, through which the printed sheet (a signature) in a folded state is passing, from the thickness of the print paper and the physical property of the sheet. Accordingly, the optimum values of the gap between rollers to be previously organized into a database on the basis of the thickness and the physical property of the print paper inevitably have errors.

Further, a printed sheet has a partial deviations in quality and thickness which are however minute extents. In addition, the surface state of folding rollers also varies due to adhesion of paper dusts or other reasons while a print operation is being performed. These deviation and variation may vary the friction between the folding rollers and the printed sheet during a print operation and may vary the actual transfer state of a printed sheet through the folding rollers even if the gap between the folding rollers have been set in advance.

However, each of Patent References 1-3 previously determines a target value for the gap and adjusts the gap to the target value, and therefore cannot deal with the variation in actual transfer state of the printed sheet through the folding rollers caused during a print operation.

With the foregoing problems in view, the first object of the present invention is to provide an apparatus and a method for adjusting a gap between folding rollers of a printed press and a printing press which can automatically adjust the gap to be suitable for signatures to pass through the gap between the two folding rollers.

More in details, object of the present invention is to provide an apparatus and a method for adjusting a gap between folding rollers of a printed press and a printing press which can adjust the gap to be suitable for signatures to pass through the gap between the two folding rollers without preparing a huge database.

The third object of the present invention is to provide an apparatus and a method for adjusting a gap between folding rollers of a printed press and a printing press which can finely adjust the gap between folding rollers according to the actual transfer state of a printed sheet through the folding rollers, inhibiting decline in product quality and operation efficiency.

### Means for Solving the Problems

To attain the above objects, as a first generic feature, there is provided an adjusting apparatus for a gap between folding rollers of a printing press, comprising: a gap adjusting mechanism, mounted to the printing press, for adjusting the gap between a pair of the folding rollers which press and fold a signature formed by cutting one or more printed sheets; a detecting unit for detecting transfer state information relative to actually passing the printed sheets through the gap between the pair of the folding rollers; and a controller for controlling the gap adjusting mechanism so that the gap between the folding rollers corresponds to the transfer state information detected by the detecting unit.

With this configuration, since the gap between a pair of folding rollers are adjusted on the basis of the transfer state of the printed sheet actually passing through the gap between a pair of the folding rollers, the gap between the rollers can be surely optimized.

As a preferable feature, the detecting unit may include a sensor for measuring the gap between the pair of the folding rollers; the controller may control operation of the printing press, and also control operation of the actuator based on the result of the measuring by the sensor such that the gap becomes an optimum value; and if a print condition is modified, the controller may control the actuator such that the gap is an initial distance according to the print condition and then functions the printing press at a low speed before normal operation of the printing press, may determine the optimum value of the gap based on a measurement value of the gap obtained in the measuring by the sensor as the signature passes through the gap between the pair of the folding rollers, and may control the operation of the actuator such that the gap becomes the optimum value.

In the event of modification of a print condition, the optimum value of the gap is determined on the basis of the measurement value obtained when a signature is passing through the gap between a pair of folding rollers during the actual operation of the printing press, and the gap is adjusted to the optimum value determined. Thereby, the gap can be surely optimized. In particular, the adjustment on the gap can be accomplished by using the controller, so that the gap can be optimized with extreme ease. In addition, there is no requirement for preparation of a database to thereby eliminate time and cost for the preparation. It is possible to inhibit an increase in load.

As another preferable feature, the folding rollers may be chopper rollers which press and fold the signature chopper-folded, or folding-down dragging rollers which press and fold on the signature cross-folded by a folding blade of a folding cylinder.

As an additional preferable feature, the controller may function the printing press at a low speed and perform the measuring of the gap between the pair of the folding rollers through which a predetermined number of the signatures are passing on a predetermined number of the signatures, and may determine the optimum value on the basis of an average value of a number of measurement values obtained by the measuring. Thereby, the optimum value of the gap can be determined with further accuracy.

As a further preferable feature, the controller may determine a value obtained by subtracting a minute value from the measurement value to be the optimum value of the gap. Consequently, the optimum value of the gap can also be determined with further accuracy.

As a still further preferable feature, the gap adjustment mechanism may include: a force applying member for applying a force to the pair of the folding rollers in such a direction that widening of the gap between the pair of the folding rollers is restricted; a movable stopper member being opposed to the force applying member and being in contact with a supporting member in such a direction that narrowing of the gap between the pair of the folding rollers is restricted; and a position adjusting member for adjusting a position of the movable stopper member, and the actuator may drive the position adjusting member.

Preferably in this case, the movable stopper member may have a first stopper member being in contact with one of the pair of the folding rollers and a second stopper member being in contact with the other of the pair of the folding rollers, the first stopper member and the second stopper member being formed with screw threads of the opposite directions from each other, the position adjusting member may be a screw axis formed with external threads each threadedly engaging with one of the screw threads of the first stopper member and the second stopper member; and the first stopper member and the second stopper member may not be rotated by rotation of the screw axis such that the first stopper member and the second stopper member come close to each other or depart from each other according to the rotation of the screw axis.

As a still further preferable feature, the gap adjusting mechanism, the actuator and the sensor may be dedicated to each of the folding rollers, and the controller may control the operation of the actuators based on the measurement value obtained by the sensors.

As a still further preferable feature, the print condition may include at least one of a kind of the printed sheets (including the paper thickness), the number of pages (corresponding to the number of folding) or a folded state of the signature entering between the pair of the folding rollers (a state of longitudinal folding and cross folding), a state of ink transferring in the printing (e.g., including an image area percent on the printing plate and the thickness of transferred ink) and a printing atmosphere (e.g., including the temperature and the humidity when the printing is being performed).

Otherwise, as a still further preferable feature, the detecting unit may be a first detector arranged downstream of the pair of the folding rollers in relation to a transferring direction of the printed sheet and detects passage of the printed sheets; and the controller may compare an actual pass time period of the printed sheets obtained from a detection signal from the first detector with a predetermined pass time period, and adjusts the gap between the pair of the folding rollers on the basis of the result of the comparing.

With this configuration, the first detector is arranged downstream of a pair of folding rollers in the transfer direction of the printed sheet to surely detect the passage of the printed sheet by the folding rollers. Accordingly, the time period during which the first detector detects the printed sheet, i.e., emits a detection signal corresponds to a passing time period during which the printed sheet is actually passing through the folding rollers.

Since the length of the printed sheet passing through a pair of the folding rollers is fixed, the predetermined pass time period for which the printed sheet takes to pass through the folding rollers can be calculated by dividing the length by the moving speed of the printed sheet on the surfaces of the folding rollers, i.e., the printing speed.

For example, if minute variations in quality and thickness of the printed sheet or variation in the surface state of the printed sheet and the folding rollers vary the friction state between the folding rollers and the printed sheet during a print operation to generate a slip of the printed sheet between the rollers, the moving speed of the printed sheet comes to be lower than the moving speed of the surfaces of the folding rollers, i.e., the printing speed. In this case, an actual moving speed and a predetermined moving speed of printed sheets having the same length in the transfer direction are different from each other, in other words, an actual pass time period is different from the predetermined pass time period. Specifically, an actual pass time caused from a lower moving speed is longer than the predetermined pass time period. In such a case, the controller instructs the adjusting member to narrow the gap of a pair of folding rollers and the adjusting member narrows the gap in the present invention.

In the above manner, the present invention adjusts the gap between a pair of folding rollers on the basis of comparison of an actual pass time period and the predetermined pass time period of the printed sheet, so that the gap between a pair of folding rollers can be finely adjusted according to an actual transfer state of printed sheets by the folding rollers during the print operation such that transfer timing of printed sheets becomes constant.

With this configuration, predetermined operations at the downstream of a pair of folding rollers can be accomplished, inhibiting decline in product quality and operation efficiency.

As a still further preferable feature, in the adjusting apparatus of the present invention, the controller selectively may replace the predetermined pass time period with a particular one of the actual pass time periods.

The controller of the present invention selectively replaces the predetermined pass time period with a particular one of the actual pass time periods, which can realize stable control. An actual time period at the time when the operator judges to be preferable can be regarded as the predetermined time period. That makes it possible to further improve the transfer timing of the printed sheet.

As a still further preferable feature, the controller may compare a detection starting time which is a period from a predetermined reference point to beginning of the printed sheets by the first detector and a predetermined reach time which is a period froth a predetermined reference point to beginning of the printed sheets by the first detector, and may adjust the gap between the pair of the folding rollers on the basis of the result of the comparing.

Since the distance between a predetermined reference point on the transfer path of the printed sheets and a detection point of the first detector is known, a predetermined reach time at which the printed sheet reaches the first detector can be calculated by dividing the distance by the printing speed.

For example, if minute variations in quality and thickness of the printed sheet or variation in the surface state of the printed sheet and the folding rollers vary the friction state between the folding rollers and the printed sheet during a print operation to generate a slip of the printed sheet between the rollers, the moving speed of the printed sheet comes to be lower than the moving speed of the surfaces of the folding rollers, i.e., the printing speed. In this case, an actual detection starting time and a predetermined moving speed of printed sheets having the same length in the transfer direction are different from each other, in other words, an actual detection starting time is different from the predetermined reach time. Specifically, an actual detection starting time caused from a lower moving speed is longer than the predetermined reach time. In such a case, the controller instructs the adjusting member to narrow the gap of a pair of folding rollers and the adjusting member narrows the gap in the present invention.

In the above manner, the present invention adjusts the gap between a pair of folding rollers on the basis of comparison of an actual detection starting time and the predetermined reach time of the printed sheet, so that the gap between a pair of folding rollers can be finely adjusted according to an actual transfer state of printed sheets such that transfer timing of printed sheets becomes substantially constant.

With this configuration, predetermined operation at the downstream of a pair of the folding rollers can be accomplished, inhibiting decline in product quality and operation efficiency.

As a still further preferable feature, the controller may selectively replace the predetermined reach time with a particular one of the detection starting times.

The controller of the present invention selectively replaces the predetermined reach time with a particular one of the actual detection starting times, which can realize stable control. An actual time period at the time when the operator judges to be preferable can be regarded as the predetermined reach time. That can further improve the transfer timing of the printed sheet.

As a still further preferable feature, the controller may use a signal to cut the printed sheets in the cross direction as the predetermined reference point in the present invention.

With this configuration, a signal used for another control such as cut-off control can be used as a reference and there is no need to mount a new signal issuing means for which cost can be reduced.

As a still further preferable feature, the controller may use a detection starting signal issued from a second detector, which is arranged upstream of the pair of the folding rollers in relation to the transferring direction to detect passage of the printed sheets as the predetermined reference point.

With this configuration, since only the folding rollers are arranged between the first and the second detectors, a variation in the speed of the printed sheet is caused only by the friction between the printed sheets and the folding rollers but not by variation in transfer speed at the remaining part of the transfer path of the printed sheet.

As a consequence, the gap between a pair of the folding rollers can be properly adjusted.

As a second generic feature, there is provided a method for adjusting a gap between folding rollers comprising the step of: transferring a printed sheet folded in two, being interposed by a pair of the folding rollers facing each other to allow to come close to each other and depart from each other; measuring a pass time period for which the printed sheet takes to pass at a position downstream of a pair of the folding rollers in the transfer direction of the printed sheet; and adjusting a gap between a pair of the folding rollers on the basis of comparison of the measured pass time period with a predetermined pass time period.

Since the method transfers a printed sheet folded in two, being interposed by a pair of the folding rollers facing each other to allow to come close to each other and depart from each other, a pass time period is measured for which the printed sheet takes to pass at a position downstream of a pair of the folding rollers in the transfer direction of the printed sheet, and adjusts a gap between a pair of the folding rollers on the basis of comparison of the measured pass time period with a predetermined pass time period, it is possible to finely adjust the gap between the folding rollers considering the actual transfer state of the printed sheets between the folding rollers during the print operation such that the transfer timing of the printed sheet comes to be substantially constant.

With this configuration, predetermined operations at the downstream of the folding rollers can be accomplished, inhibiting decline in product quality and operation efficiency.

As a preferable feature, the step of adjusting the gap between the folding rollers may be based on comparison of a detection starting time which is a period from a predetermined reference point to beginning detection of the printed sheets at the position downstream of the folding rollers and a predetermined reach time which is a period from a predetermined reference point to reaching of the printed sheets to the position downstream of the folding rollers.

As described above, since the gap of the pair of the folding rollers are adjusted on the basis of comparison of the detection starting time at the position downstream of the folding rollers from a predetermined reference point and the predetermined reach time at the position downstream of the folding rollers from a predetermined reference point, it is possible to finely adjust the gap between the folding rollers in accordance with the transfer state of the printed sheets between the folding rollers during the print operation such that the transfer timing of the printed sheet comes to be substantially constant.

With this configuration, predetermined operations at the downstream of the folding rollers can be accomplished, inhibiting decline in product quality and operation efficiency.

As a third generic feature, there is provided a printing press comprising an adjustment apparatus for a gap between folding rollers defined in one of claims 1-16.

As a fourth generic feature, there is provided a method for adjusting a gap between folding rollers which presses and folds a signature formed by cutting one or more printed sheets and which is included in a printing press including a gap adjusting apparatus to adjust the gap between the folding rollers which printing press functions the gap adjusting apparatus according to a print condition such that the gap is adjusted to be an optimum value, comprising the steps of: detecting transfer state information relative to actually passing the printed sheets through the gap between the pair of the folding rollers; and controlling the gap adjusting mechanism so that the gap between the folding rollers corresponds to the transfer state information detected in the step of detecting.

As a preferable feature, the gap adjusting apparatus may include a gap adjusting mechanism for adjusting the gap between the pair of the folding rollers and an actuator for actuating the gap adjusting mechanism; and the method further may comprise the steps of functioning the actuator such that the gap is an initial distance associated with the print condition, measuring a distance of the gap between the pair of the folding rollers through which the printed sheets are passing while the printing press is operating in a low speed, the distance serving as the transfer state information, determining the optimum value of the gap on the basis of a measurement value of the gap obtained in the step of measuring, and controlling the actuator to: function such that the gap becomes the optimum value determined in the step of determining.

As another preferable feature, the step of controlling may comprise the sub-steps of: measuring a pass time period of the printed sheet at a position downstream of the folding rollers in a direction of transferring the printed sheet; and adjusting the gap between the pair of folding roller on the basis of a result of comparison of the pass time period measured in the sub-step of measuring with a predetermined pass time period.

In this case, as a further preferable feature, the step of adjusting the gap between the folding rollers may be based on comparison of a detection starting time at the position downstream of the folding rollers from a predetermined reference point and a predetermined reach time at the position downstream of the folding rollers from a predetermined reference point.

As described above, since the gap of the pair of the folding rollers are adjusted on the basis of comparison of a detection starting time at the position downstream of the folding rollers from the predetermined reference point and a predetermined reach time at the position downstream of the folding rollers from a predetermined reference point, it is possible to finely adjust the gap between the folding rollers in accordance with the actual transfer state of the printed sheets between the folding rollers during the print operation such that the transfer timing of the printed sheet comes to be substantially constant.

With this configuration, predetermined operations at the downstream of the folding rollers can be accomplished, inhibiting decline in product quality and operation efficiency.

As a fifth generic feature, there is provided another method for adjusting a gap between folding rollers of a printing press performed by an adjusting apparatus defined in one of claims 2-10, in which method, if a print condition is modified, the controller functions the actuator such that the gap is adjusted to the optimum value before a normal operation of the printing press, comprising the step of: functioning the actuator such that the gap comes to be an initial distance associated with the print condition; measuring the gap through which the signature is passing while the printing press is operating at a low speed; determining the optimum value based on a measurement value obtained in step of measuring; and functioning the actuator such that the gap comes to be the optimum value determined in the step of determining.

As a preferable feature, the method may comprise the step of temporarily halting the printing press after completion of the step of measuring.

### EFFECT OF INVENTION

The apparatus and the method for adjusting a gap between folding rollers adjust the gap between a pair of folding rollers on the basis of the transfer state information of the printed sheets actually passing through the gap between a pair of the folding rollers, so that the gap can be surely adjusted.

Since if a print condition is modified, the optimum value of the gap between a pair of the folding rollers is determined on the basis of a measurement value of the gap obtained during actual operation of the printed sheet, the gap can be surely optimized. In particular, the adjustment on the gap can be automatically accomplished by the use of the controller, thereby accomplishing the gap optimization with extreme ease. In addition, there is no requirement to prepare a database and so time and cost for the preparation can be saved to reduce the load.

Further, the first detector is arranged downstream of a pair of folding rollers in the transfer direction of the printed sheet to surely detect the passage of the printed sheet by the folding rollers. Accordingly, the gap between a pair of folding rollers can be adjusted based on comparison of the actual pass time period and the predetermined pass time period of the printed sheet.

Since the gap between a pair of folding rollers can be finely adjusted according to an actual transfer state of printed sheets such that transfer timing of printed sheets becomes substantially constant, predetermined operation at the downstream of a pair of folding rollers can be accomplished as scheduled to, inhibiting decline in product quality and operation efficiency.

### BRIEF DESCRIPTION OF THE DRAWINGS

FIG. 1 is a diagram illustrating the configuration of a gap adjustment apparatus for a gap between folding rollers of a printing press according to a first embodiment of the present invention;

FIG. 2 is a flow diagram showing a gap adjustment method for a gap between the folding rollers of the printing press according to the first embodiment of the present invention;

FIG. 3 is a front view schematically showing the entire configuration of a rotary press of a second embodiment;

FIG. 4 is diagram schematically showing the configuration of a chopper folding unit according to the second embodiment;

FIG. 5 is a flow diagram showing a gap adjustment method according to the second embodiment;

FIGS. 6(a)-6(d) are perspective views showing a signature of the second embodiment;

FIGS. 7(a)-7(c) are diagrams schematically showing a detection state by a sheet detection unit;

FIG. 8 is a signal diagram showing an example of a detection result of the second embodiment;

FIG. 9 is a perspective view showing a conventional chopper unit and chopper rollers; and

FIG. 10 is a diagram illustrating the configuration of a conventional gap adjustment apparatus for a gap between folding rollers of a printing press.

### DESCRIPTION OF REFERENCE NUMBERS

1, 1a signature
11 transfer belt
12 chopper table
12a slit
13 chopper blade
14, 14A, 14B chopper roller (folding roller)
15, 15A, 15B supporting arm
15a first end (upper end) of supporting arm
15b second end (lower end) of supporting arm
16 supporting axis
17 gap adjusting mechanism
18 spring
19, 19A, 19B movable stopper member
19A first stopper member
19B second stopper member
20 screw axis
21 handle
22 motor (actuator)
23 sensor
24 controller (controller)
101 rotary press
130 transfer direction
150b signature
163 gap control unit (controller)
169 folding roller (folding roller)
177 motor
179 sheet detecting unit
199 sheet detecting unit
A0 predetermined pass time period
A1 actual pass time period
B0 estimated reach time
B1 detection starting time

### BEST MODE FOR CARRYING OUT THE INVENTION

Hereinafter, embodiments of the present invention are described with reference to the accompanying drawings.

### First Embodiment

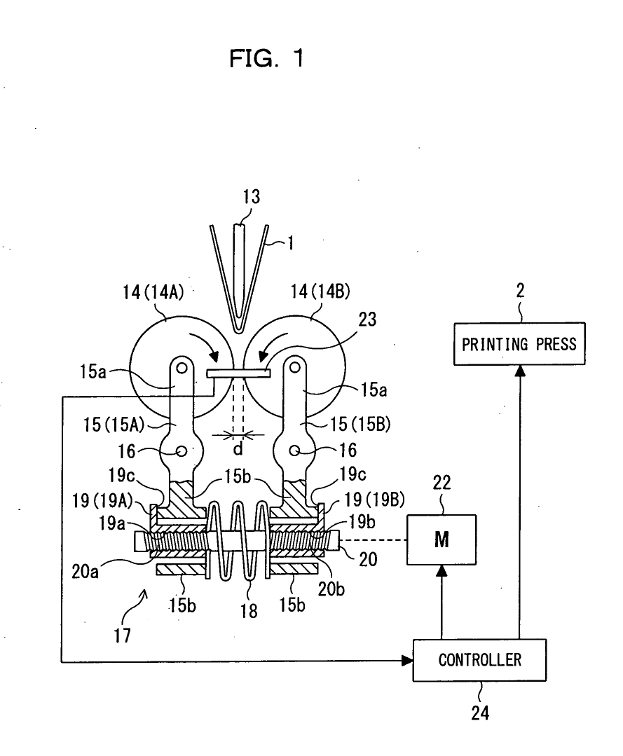

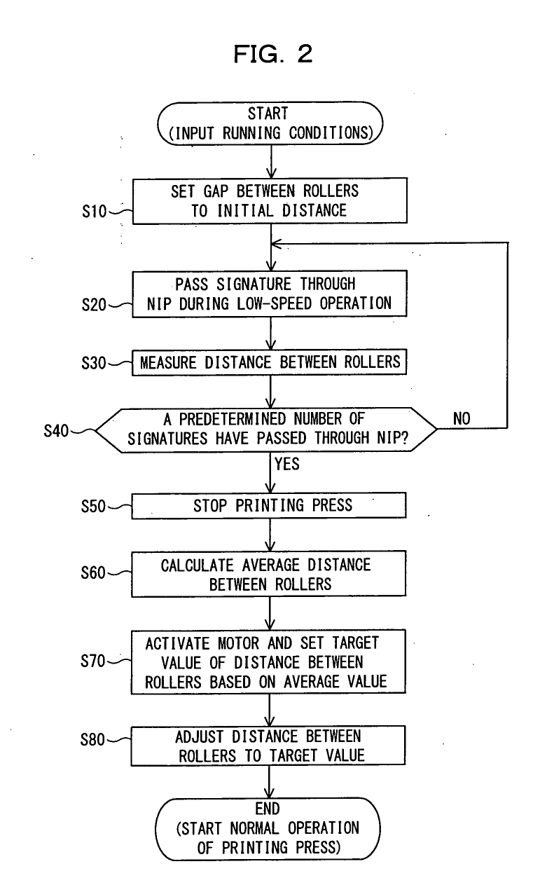

FIGS. 1 and 2 are a gap adjusting apparatus and a gap adjusting apparatus (sic, correctly method) for folding rollers of a printing press according to the first embodiment: FIG. 1 shows the configuration of the gap adjusting rollers and FIG. 2 is a flow diagram showing the gap adjusting method.

(Apparatus Configuration)

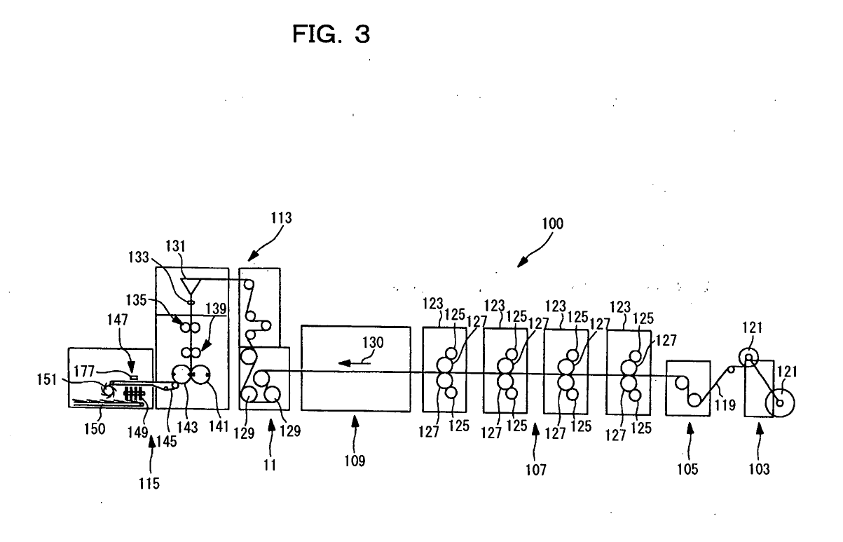

Folding rollers of the present embodiment take the form of chopper rollers which are positioned downstream of the chopper device described above to be conventional. The chopper device is, as shown in FIG. 3, mounted to a rotary press such as a commercial-use offset rotary press, and folds signature 1, which has been transferred from the upstream on transfer belt 11, on chopper table 12 with chopper blade 13 which is located over slit 12a of chopper table 12 and which makes vertical movement. Then the chopper device sends folded signature 1a between a pair of chopper rollers (folding rollers) 14 and 14 which are positioned under chopper table 12 through slit 12a. Passing through the gap between chopper rollers 14 and 14, signature 1a is fold by being pressed by chopper rollers 14 and 14 and is then sent out to an ejector (not shown) formed below the chopper rollers 14 and 14.

The gap adjusting apparatus of folding rollers of a printing press of the first embodiment adjusts the gap between chopper rollers (hereinafter simply called rollers) 14 and 14, and includes, as shown in FIG. 1, gap adjusting mechanism 17 for adjusting the gap between the pair of rollers 14 and 14, electric motor (actuator) 22 for actuating gap adjusting mechanism 17, distance sensor 23 for measuring the distance of gap d between chopper rollers 14 and 14, and controller 24 for controlling operation of motor 22 based on the measurement result of sensor 23 such that gap d is optimum in addition to controlling operations of printing press 2.

Also in the first embodiment, each of rollers 14 and 14 is rotatably supported by first end (the upper end) 15a of supporting arm 15 swingably pivots around supporting axis 16. The gap between rollers 14 and 14 is widened by making the second ends (the lower ends) 15b of supporting arms 15 closer to each other, and the gap is narrowed by departing the second ends 15b of supporting arm 15 from each other. Gap adjusting mechanism 17 restricts first ends 15a of supporting arms 15 to come close to each other, allowing the ends 15a to depart from each other.

In other words, gap adjusting mechanism 17 includes spring (a force applying member) 18 arranged between the second ends 15b of supporting arms 15, movable stopper members 19 each of which is arranged on the outside of the second end 15b of one of supporting arms 15 and is in contact with the same second end 15b, and screw axis (a position adjusting member) 20 for adjusting the positions of stopper members 19.

When a pair of rollers 14 and 14, a pair of supporting arms 15 and 15, and stopper members 19 and 19 are discriminated from each other, the one (on the left side in FIG. 1) of the pairs are called first roller 14A, first supporting arm 15A, and first stopper member 19A, and the other (on the right side in FIG. 1) of the pairs are called second roller 14B, second supporting arm 15B, and second stopper member 19B.

Accordingly, in gap adjusting mechanism 17, second ends 15b of supporting arms 15A and 15B are forced by spring 18 in such a direction that arms 15A and 15B depart from each other, but stoppers 19A and 19B limits the movement of arms 15A and 15B in the direction departing from each other. Consequently, second ends 15b of supporting arms 15A and 15B are able to come close to each other against the force applied by spring 18, but the movement of second ends 15b of arms 15A and 15B in the direction departing from each other is limited by stoppers 19A and 19B. Focusing on the gap between rollers 14A and 14B, rollers 14A and 14B are limited to coming closer to each other than the gap determined by stopper members 19A and 19B, so that the rollers 14A and 14B are allowed to depart from each other.

In the illustrated example, a ring-shaped portion is formed on second end 15b of each of supporting arms 15A and 15B in which portion stopper member 19A or 19B is incorporated. Each of stopper member 19A and 19B includes contacting face 19c in contact with the outward face of second end 15b and screw thread 19a or 19b. Revolution of stopper member 19A and 19B is restricted by non-illustrated revolution limitation mechanism.

On the outer circumference surface of screw axis 20, first external thread 20a and second: external thread 20b are formed at a predetermined distance. First external thread 20a is a right hand thread, and second external thread 20b is a left hand thread. In the meanwhile, first screw thread 19a of first stopper member 19A is a right hand thread to fit right-hand external thread 20a, and second screw thread 19b of second stopper member 19B is a left hand screw to fit left-hand external thread 20b. Further, to one end (the right end in FIG. 1) of screw axis 20, motor 22 to rotationally drive screw axis 20 is connected.

With this configuration, when motor 22 is activated to rotate screw axis 20 rightwards as viewed from the right side in FIG. 1, first stopper member 19A with right-hand screw thread 19a moves right and second stopper member 19B with left-hand screw thread 19b moves left. Namely, both stopper members 19A and 19B come close to each other. Conversely, rotation of screw axis 20 leftwards as viewed from the right side in FIG. 1 causes both stopper member 19A and 19B to depart from each other.

Sensor 23 to measure the gap d between a pair of the rollers 14 and 14 may be a non-contact sensor directly measuring the gap between rollers 14 and 14. Since the gap d between rollers 14 and 14 correlates with a distance between movable vertical position of first ends 15a or second ends 15b of supporting arms 15 and 15 or with a tilt angles of supporting arms 15A and 15B, such a distance or a tile angle may be measured and the gap d between rollers 14 and 14 may be calculated on the basis of the measured distance or the tilt angle.

Supporting axis 16, supporting arm 15, gap adjusting mechanism 17, motor 22, and sensor 23 are disposed on each of first end and the second end of rollers 14A and 14B, and the gap between rollers 14A and 143 is individually adjusted on both rollers 14A and 14B.

Controller 24 controls operation of printing press 2 and motor 22 according to predetermined programs. For adjustment of a gap between rollers, if a predetermined modification is made on a print condition, controller 24 performs a gap adjustment process on each of rollers 14A and 14B.

The print conditions here are a kind (including the thickness) of a printed sheet to undergo printing, the number of pages (folds) of signature 1a to enter between rollers 14 and 14 or a folded state (a state of longitudinal- or cross-direction folding), a state of ink transferring (including, for example, an image-area ratio of a print plate, an ink transfer thickness or the like), and the atmosphere (e.g., the temperature and the humidity when printing is being carried out), each of which can cause to vary the thickness of signature 1a entering between rollers 14 and 14.

In other words, a variation in the thickness of a printed sheet varies the thickness of signature 1a entering between rollers 14 and 14 and the thickness of signature 1a varies in accordance with a variation in the number of pages of the signature 1a. Even if the number of pages of signature 1a does not vary, a change in the kind of the printed sheet varies the bulk of signature 1a being in a folded state and therefore the substantial thickness of signature 1a varies. The change in the folded state of signature 1a also varies the substantial thickness of signature 1a. In addition, a higher image-area percent and a larger ink transfer thickness increase the substantial thickness of signature 1a and conversely, a lower image-area percent and a smaller ink transfer thickness decrease the substantial thickness of signature 1a even though the amount of the increase or the decrease is quite small. In other words, the substantial thickness of signature depends on an ink transfer state. Further, the substantial thickness of signature depends also on the temperature and the humidity when the printing is being performed.

Considering such print conditions, if the thickness of signature 1a entering between rollers 14 and 14 is judged to vary, the gap between the rollers is adjusted. In this embodiment, every time when the kind of a printed sheet undergoing printing changes, or every time when the number of pages or a folded state of signature 1a entering between rollers 14 and 14 varies, the thickness of signature 1a is judged to vary. When an ink transfer state varies more than a predetermined reference or the print atmosphere varies more than a predetermined reference, the thickness of signature 1a is judged to possibly vary.

Controller 24 includes a function (a judging section) for judging, when print conditions for the next print operation of the printing press are input, whether or not the thickness of signature 1a is to vary. If the judging section judges that the thickness of signature 1a is to vary, controller 24 functions in accordance with a control program to adjust the gap between rollers 14 and 14 as shown in FIG. 2 after the previous printing is completed and the printing press halts. Hereinafter, the procedural steps are detailed with reference to FIG. 2.

(Procedural Step Configuration)

This control is initiated when the judging section judges that the thickness of signature 1a is to vary and printing press 2 halts due to completion of the previous printing. First, the gap between rollers 14 and 14 is set to be the initial distance while printing press 2 halts (step S10). The initial distance is given in terms of the above print conditions. Specifically, a rough thickness of signature 1a is estimated on the basis of the above print conditions and the initial distance is used to preset the gap between rollers 14 and 14 in the next process to surely be smaller than the thickness of signature 1a. Consequently, the initial distance may be a rough value.

Here, on the basis of the above print conditions, each of a kind of a printed sheet undergoing printing, the number of pages of signature 1a entering between rollers 14 and 14 and the folded state of the signature 1a is classified into several classes, and a combination of these conditions determines a rough thickness of signature. Alternatively, the operator may select and input one from several predetermined initial distances according to the print conditions.

Next, controller 24 starts printing press 2 to operate at a low speed and sends signature 1a which is formed by being printed, cut, and folded into a predetermined state to the chopper device, where chopper blade 13 further folds signature 1a and sends the signature 1a between rollers 14 and 14 (step S20). The low speed here is 20 rpm or lower, which is greatly lower than the normal running speed of 800 rpm.

While printing press 2 is running at such a low speed, since the gap between rollers 14 and 14 is set to surely be smaller than the thickness of signature 1a in the previous step (i.e., step S10), the signature 1a entering between rollers 14 and 14 causes rollers 14 and 14 to depart from each other, compressing spring 18. Sensor 23 measures the distance between rollers 14 and 14 or the parameter corresponding to the distance at which the rollers 14 and 14 depart furtherest from each other, and detects or calculate the distance between rollers 14 and 14 through which signature is able to pass without ample gap (step S30).

In this embodiment, a predetermined number (several, e.g. three) of signatures 1a are passed through the gap between rollers 14 and 14 (step S40), and a corresponding number of results of measurement (or calculation) dm of the distance d between rollers 14 and 14 are obtained. After a number of distances dm between rollers 14 and 14 are obtained, the procedure temporarily stops printing press 2 (step S50) and calculates the average value day of the obtained distances dm between rollers 14 and 14 (step S60).

Next, on the basis of the average distance day between rollers 14 and 14, a target value (the optimum value) dt of the gap between rollers 14 and 14 is set (step S70). In the first embodiment, the target value (the optimum value) dt is calculated by multiplying the average value day of the distance d between rollers 14 and 14 and a coefficient k slightly smaller than 1 (i.e., dt=k·dav, where k=1 and k≈1). It is because the gap is preferably set to be slightly smaller than the thickness of signature 1a in order to smoothly pass the signature 1a through the gap between rollers 14 and 14 and, at the same time, surely folding the signature 1a. The gap between rollers 14 and 14 same as the thickness of signature 1a does not apply sufficient pressure to fold the signature 1a. Conversely, the gap between rollers 14 and 14 much narrower than the thickness of signature 1a cannot let the signature 1a smoothly pass through the gap. Alternatively, the target value (the optimum value of the gap) dt may be calculated by subtracting a minute value s from the average value day of the distance between rollers 14 and 14 (i.e., dt=dav−s, where 0≦s<<1).

The distance d between rollers 14 and 14 is adjusted on the basis of the set target value (the optimum value of the gap) dt. Specifically, motor 22 is activated and rotated in a predetermined direction at a predetermined angle to adjust the distance between stopper members 19A and 19B. That adjusts the gap between second ends (the lower ends) 15b of both supporting arms 15A and 15B and thereby the gap between first ends (the upper ends) 15a of both supporting arms 15A and 153, which respectively support rollers 14A and 14B. Finally, the distance d between rollers 14 and 14 is adjusted to be the target value (the optimum value of the gap) dt.

The above adjustment for the distance d between rollers 14 and 14 is performed at each individual roller 14.

(Result and Effect)

In the gap adjusting apparatus and method for a gap between folding rollers of a printing press of the first embodiment of the present invention configured as above, when print conditions are modified to vary the thickness of signature 1a entering between rollers 14 and 14, the target value (the optimum value)dt of the gap between rollers 14 and 14 is determined on the basis of the measured value (or the value calculated based on measurement results) dm between rollers obtained by passing signature 1a between rollers 14 and 14 while the printing press is functioning (at a low speed) and the gap d between rollers 14 and 14 is adjusted to the set target value (the optimum value) dt. That can surely optimize the gap between rollers 14 and 14.

Further, since the measurement of the gap is carried out while the printing press is at a low speed, the amount of paper loss can be small. In the present embodiment, since the gap between rollers 14 and 14 is measured by passing a number (e.g., three) of signatures 1a and the measurement value of the gap between rollers 14 and 14 is obtained by averaging the measurement results, the distance between rollers 14 and 14 can be obtained with accuracy and, also in this case, the amount of lost paper is small (several signatures).

The adjustment of the gap between rollers 14 and 14 is automatically performed by controller 24, so that the gap can be easily optimized, reducing the load on the operator. In addition, in the first embodiment, since judgment as to whether or not adjustment of the gap between rollers 14 and 14 is to be carried out is automatically made and the initial distance between rollers 14 and 14 when the adjustment of the gap is automatically set, a certain scale of a database is required but the scale of the database need not to be excessively large. That greatly reduces time and cost for preparation of the database, in other words, avoiding increase in burden.

Further, setting the target value (the optimum value) dt of the gap to be slightly smaller than the measurement results (the average) day of the distance between rollers 14 and 14 makes it possible to smoothly pass signatures 1a between rollers 14 and 14, applying requisite pressure to fold signatures 1a.

Still further, since the first embodiment adjusts the gap while printing press 2 is temporarily stopped after the step of measuring the gap (a measurement step), the gap adjustment can be performed, reducing the generation of paper loss.

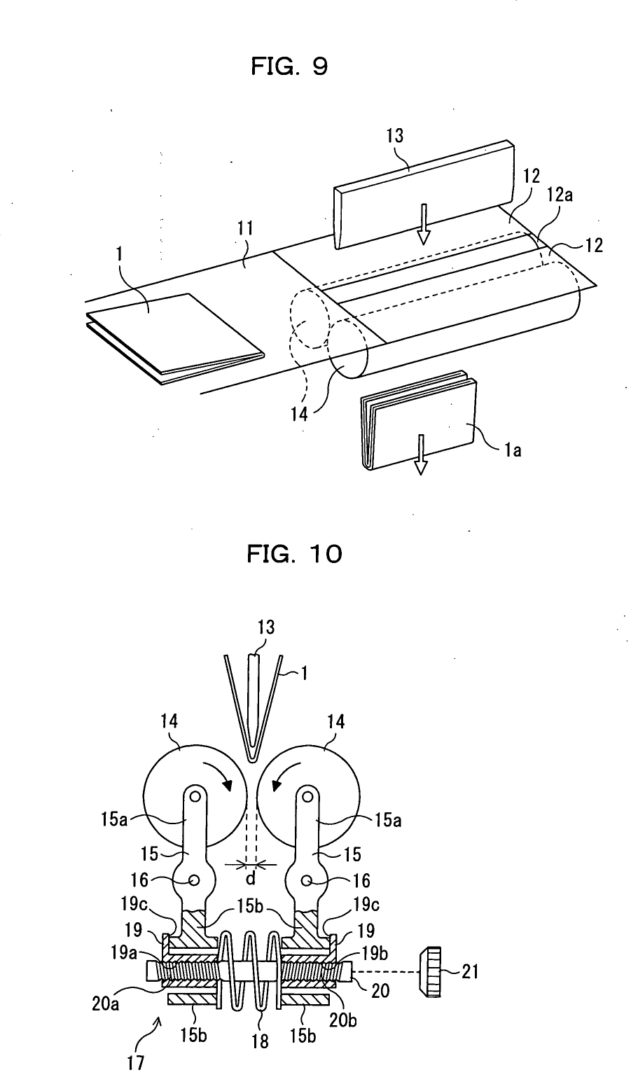

For example, signature 1a entering between rollers 14 and 14 may have, as shown in FIG. 9, one side (the right side in the drawing) being folded or may have opposite sides folded different times. Although signature 1a being folded a larger number of times becomes thicker, the apparatus and the method of the first embodiment carry out adjustment of the gap on the basis of the actual thickness of signature with each individual roller 14. Thereby, rollers 14 and 14 forms therebetween a gap which is corresponding to the actual thickness of each end of the signature 1a and which is not perfectly parallel, in other words, appropriately non-parallel (the extent of which is however slight, so the gap still can be considered to be substantially parallel). As such, the first embodiment can smoothly pass signatures 1a through the gap between rollers 14 and 14, applying requisite pressure to fold the signatures 1a.

The first embodiment of the present invention is detailed as above, but the present invention should by no means be limited to the foregoing first embodiment and various modifications can be suggested without departing from the sprit of the present invention.

For example, the description of the first embodiment concerns chopper rollers, serving as folding rollers, which press signatures chopper folded to fold the signatures. The present invention can be applied to other folding rollers, such as folding-down dragging rollers which press signatures cross-folded by a folding bade of a folding cylinder to fold the signatures.

It is sufficient that the gap adjusting mechanism has a function for adjusting the gap between folding rollers, and the mechanism should not therefore be limited to that of the foregoing embodiment. The configuration of the actuator should associate with that of the gap adjusting mechanism, but should by no means be limited to an electric motor as used in the first embodiment. An alternative actuator may be a fluid pressure motor such as air pressure motor or a hydraulic pressure motor, a fluid pressure cylinder such as an air pressure cylinder or a hydraulic pressure cylinder, a linear motor driven by electricity or a fluid pressure.

In addition, in the first embodiment, processes related to the gap adjustment including judgment as to whether or not gap adjustment is to be performed and setting the initial distance between rollers 14 and 14 are automatically executed by controller 24. Alternatively, a part of the process, such as judgment as to whether or not gap adjustment is to be performed and setting the initial distance may be carried out by an operator.

Further, the distance between rollers 14 and 14 is measured by passing a number of signatures 1a through the gap in the first embodiment. The gap may be alternatively measured by passing a single signature 1 or another appropriate number signatures 1a through the gap.

Still further, the first embodiment temporarily halts printing press 2 after the steps of measuring the gap (the measurement step), but gap adjustment may be carried out without halting printing press 2, which is alternatively working at a low speed. In this case, although an amount of paper loss surely increases, gap adjustment can be accomplished in a shorter time saved by eliminating the requirement for temporarily halting printing press 2 and ensuing restarting printing press 2.

If signatures always require a gap perfectly parallel and there is consequently no need to form a non-parallel gap, a single sensor may be arranged on either roller 14 and both ends of rollers 14 and 14 may be controlled to become the same sate based on the value obtained by the single sensor or based on the average values obtained by sensors arranged on the both sides.

In the first embodiment, the target value (the optimum value of the gap) dt is obtained by multiplying the measurement value of the gap (the average value day of the gap between rollers 14 and 14) and a coefficient k slightly smaller than 1 or by subtracting a minute value s from the measurement value of the gap. Alternatively, such a correction coefficient k or a correction amount s may be set according to one of the input print conditions described above, a print speed of actual printing (in which the printing is in normal operation) or combination of an input print condition and a print speed.

### Second Embodiment

Next, a second embodiment of the present invention will now be described with reference made to FIGS. 3-8.

The second embodiment applies the present invention to a rotary press with opposing blankets for multicolor printing on both sides of a web.

FIG. 3 is a front view showing the entire configuration of rotary press 101.

Rotary press 101 includes web feeder 103, in-feed unit 105, printer section 107, dryer 109, cooling section 111, web passing section 113, and folder 115 which are arranged along transfer direction 130 of web 119.

Web feeder 103 feeds web 119 and has a configuration to accommodate two web rolls 121 formed by rolling web 119.

While one of web rolls 121 feeds web 119, the other web roll 121 is mounted to prepare splicing the web. When a low amount of web 119 remains at one web roll 121, the web 119 is spliced to web 119 of the other web roll 121. Then, while the other roll 121 feeds web 119, the one web roll 121 is mounted to prepare splicing the web.

In this manner, web 119 is continuously supplied toward the downstream from web feeder 103 in the transfer direction 130.

In-feed unit 105 adjusts the tension of web 119 fed from web feeder 103 and then supplies the web 119 to printer section 107.

Printer section 107 includes a number of print units 123 of the number that corresponded to the number of colors to be printed.

In this embodiment, printer section 107 includes four print units 123 each of which printing cyan, yellow, magenta and black, which accomplish multicolor printing in use of color mixture.

Each print unit 123 includes two sets of plate cylinder 125 and blanket cylinder 127.

The blanket cylinders 127 of different sets are arranged to face each other and be interposed by web 119, and apply printing pressure to each other. A dampening unit and an inking unit are arranged around the circumference of each plate cylinder 125, which are however not illustrated. A dampening unit applies fountain solution onto the printing plate wrapped around plate cylinder 125, and an inking unit applies ink onto the plate cylinder.

Dryer 109 has a function to heat web 119 both sides of which have undergone printing to dry the web 119.

Cooling section 111 includes a number of cooling drums 129 to cool web 119, which has been heated by dryer 109 while the web 119 travels in contact with the circumference surface of cooling drums 129.

Web passing section 113 has functions to adjust the tension of web 119, fold the web 119 in half along transfer direction 130 with triangle former 111, and supply the folded web 119 to folder 115. In addition, web passing section 113 has a cutting function to longitudinally cut web 119 if required.

Triangle former 131 longitudinally folds web 119 or rotates the traveling direction of the surface of narrow web 119 by 90 degrees.

Lead-in rollers 133 take the form of a pair of rollers having a gap therebetween, and guide web 119 longitudinally folded by triangle former 131 downwards.

Folder 115 includes first nipping roller section 135, second nipping roller section 139, folding cylinder 141, gripper cylinder 143, transfer belt 145, chopper folding device 147, cross-folding impeller 149, parallel-folding impeller 151, and delivery conveyer 153.

First nipping roller section 135 and second nipping roller section 139 have functions to apply tension: to web 119 and send the web to downstream.

Around the circumference surface of folding cylinder 141, two pairs of folding blades are arranged at intervals of substantial 180 degrees, and additionally a needle unit and cutting blade are arranged in order to transfer web 119 and cut off web 119, respectively.

Around the circumference surface of gripper cylinder 143, two pairs of grippers are arranged at intervals of substantial 180 degrees. The positions of grippers are set to correspond to the folding blade(s) of folding cylinder 141.

Transfer belt 145 is positioned below gripper cylinder 143 and receives signatures 1a from gripper cylinder 143 to transfer the signatures to downstream. Transfer belt 145 are formed by a number of belts 155 arranged in the cross direction in substantially parallel. Individual signatures of different forms are denoted by reference numbers 150a through 150d, but signatures the form of which is not discriminated is denoted by reference number 150.

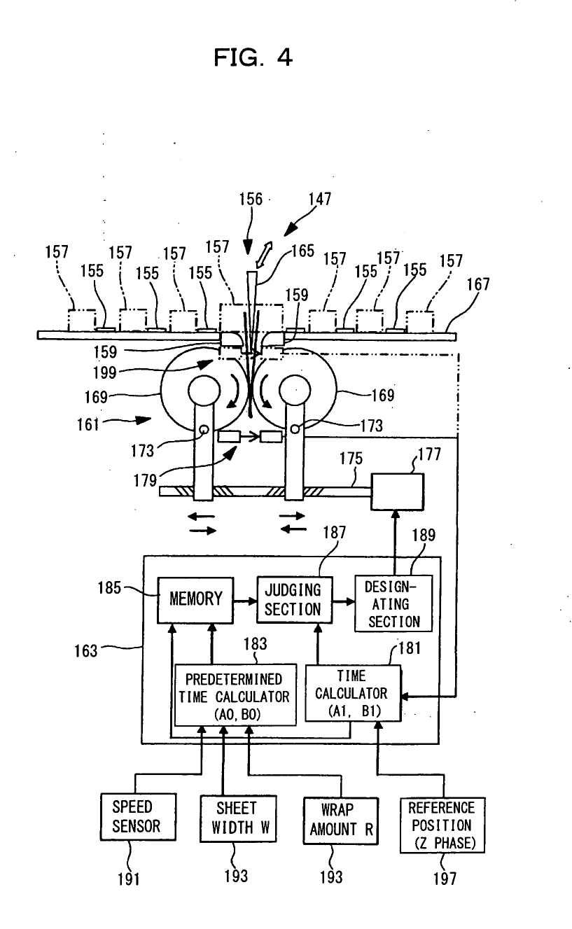

Next, chopper folding device 147 will now be detailed with reference to FIG. 4.

Chopper folding device 147 is arranged at the middle of the travel direction of transfer belt 145.

Chopper folding device 147 includes chopper folding member 156, stoppers 157, a pair of folding guides 159, folding roller unit 161 (folding rollers), signature guide (not shown), and gap control unit (control unit) 163 serving as a controller.

Chopper folding member 156 includes folding blade 165, which is formed by board in the shape of a substantially rectangular and which moves upwards and downwards at predetermined timings in harmony with swing of a non-illustrated chopper arm.

Guide board 167 is positioned substantial horizontally and guides upper belt 155 of transfer belt 145.

At the substantially middle of the cross direction of guide board 167, a strip opening is formed in parallel with the transfer direction. A pair of folding guides in the form of a bar of quarter circle is attached on the both edges of the opening.

The pair of folding guides 159 is arranged in such a posture that the circumference portions of the guides face each other and form a gap therebetween. The gap gradually decreases towards the bottom. Folding blade 165 is formed to pass through between the pair of folding guides 159.

Stoppers 157 are formed at the downstream of folding blade 165 and are shifted upwards and downwards by a non-illustrated driving mechanism.

The lower faces of stoppers 157 come in contact with the upper face of guide board 167 when stoppers 157 move downwards to stop signature 150b being transferred in transfer direction 130.

Folding roller unit 161 includes a pair of folding rollers (folding rollers) 169, which are arranged in such a posture that the imaginary axes of the rollers are along transfer direction 130 below the folding guides 159.

The pair of folding rollers 169 is rotationally driven such that the facing positions move downwards.

Each of folding rollers 161 serving as a pair engages with swinging member 171 which swingably rotates around pivot 173 that is the center of the axis. The lower parts of swinging members 171 are screw into thread axis 175 having threads formed in opposite directions.

Thread axis 175 is driven and rotated by motor (adjusting member) 177 with a decelerator. Rotation of thread axis 175 swings swinging members 171 in opposite directions, so that folding rollers 169 forming a pair come close to each other or depart from each other to adjust the gap between the rollers.

Sheet detecting unit (first detector) 179 is arranged immediately downstream of the pair of folding rollers 169.

Sheet detecting unit 179 is exemplified by a passage detection sensor of photo-transmitter/receiver type and emits different signals between when a sheet is passing through and is not passing through (here, assuming that “on” signals are emitted only when signatures 150c and/or 150d are passing).

Gap control unit 163 includes time detector 181, predetermined time calculator 183, memory 185, judging section 187, and designating section 189.

Time detector 181 calculates actual pass time period A1 for which signature 150c or 150d takes to pass through based on a detection signal emitted from sheet detecting unit 179.

Further, time detector 181 calculates detection starting time B1 on the basis of the detection signal by sheet detecting unit 179, regarding the phase on which web 119 is cut between folding cylinder 141 and gripper cylinder 143 as the reference position of the Z phase, for example.

Into predetermined time calculator 183, sheet Width W and wrap amount R of web 119 input with input means (e.g., a keyboard) 193 and a print speed detected by speed sensor 191, i.e., the machine speed are input. On the basis of these information pieces, predetermined time calculator 183 calculates predetermined pass time period A0 of signature 150c or 150d.

In addition, estimated reach time B0 at which signature 150c or 150d reaches the position of sheet detecting unit 179 is calculated from the reference position of the Z phase and the distance between the cutting position and the position of sheet detecting unit 179.

Memory 185 retains actual pass time period A1 and detection starting time B0 of time detector 181, and predetermined pass time period A0 and estimated reach time B0 of predetermined time calculator 183.

Actual pass time period A1 and detection starting time B0 of memory 185, and predetermined pass time period A0 and estimated reach time B0 from predetermined time calculator 183 are input into judging section 187, which determines whether or not the gap between the pair of folding rollers 169 is appropriate.

Designating section 189 issues a control signal based on the judgment made by judging section 187 to activate motor 177 and thereby adjusts the gap between the pair of folding rollers 169.

Cross-folding impeller 149 is formed under chopper folding device 147 and transfers signature 150c and 150d which have been chopper-folded (cross-folded) by chopper folding device 147 to delivery conveyer 153.

Parallel-folding impeller 151 is arranged downward and below transfer belt 145 in such a posture that the axis of the impeller is perpendicular to transfer direction 130.

Parallel-folding impeller 151 passes signature 150b which has not been folded by chopper folding device 147 and which is being transferred by transfer belt 145 over to delivery conveyer 153.

Now, the operation performed by rotary press 101 described above will be detailed.

Web 119 fed from web feeder 103 is sent to print unit 123 of the printing section after the tension of web 119 is adjusted by in-feed unit 105.

At each print unit 123, an image formed by applying fountain solution and ink onto on a printing plate wrapped around circumference surface of plate cylinder 25 is transferred to blanket cylinder 127. Images formed on blanket cylinders 127 and 127 are transferred to the both sides of web 119 passing between blanket cylinders 127 and 127 and thereby printing is performed.

Images each in cyan, yellow, magenta, and black are printed on web 119 while passing through four print units 123, by which multi-color printing is accomplished.

Web 119 undergone multicolor printing while passing through print units 123 is heated by dryer 109 and the ink is dried.

In succession, web 119 is cooled by cooling drums 129 while web 119 travels in contact with the circumference surface of each cooling drum 129 of cooling section 111. The tension of web 119 is adjusted by web passing section 113 and the web 119 is longitudinally folded by triangle former 131 and then supplied to folder 115.

In folder 115, web 119 is sent downstream by first nipping roller section 135 and second nipping roller section 139, and fed between folding cylinder 141 and gripper cylinder 143 rotating in opposite directions.

Folding cylinder 141 sticks a needle of the needle unit into an edge of web 119, and thereby rotates the web 119, while holding the web 119.

Web 119 transferred by rotation of folding cylinder 141 is folded into a gripping member of gripper cylinder 143 at a predetermined position by a folding blade projecting from folding cylinder 141 and is gripped by the gripping member. At this timing, the needle unit of folding cylinder 141 withdraws and web 119 is passed over to gripper cylinder 143.

When web 119 being transferred and held by gripper cylinder 143 comes to a predetermined position, the web is cut in the cross direction.

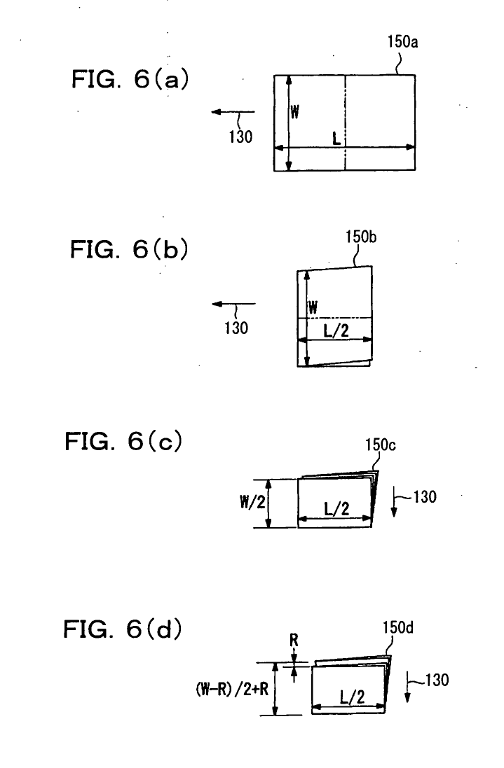

For convenience, the cut web 119 is regarded as signature 150a (see FIG. 6(a)) even though the web is different in shape from the signature 150a. Signature 150a has the length L, that is, the cut length L, and the width W.

Signature 150a is folded in two in the cross direction by folding cylinder 141 and gripper cylinder 143 to become signature (the printed sheet) 150b, which has the length L/2 and the width W in the transfer direction 130 (see FIG. 6(b)).

At the time when signature 150b comes on transfer belt 145, the gripping member opens to pass the signature 149b to transfer belt 145.

As a result of repeating the above process, signatures 105b are successively conveyed on transfer belt 145 at intervals.

When signature 150b conveyed on transfer belt 145 reaches chopper folding device 147, stoppers 157 move downwards at a right timing to halt the edge (on the downstream side) of signature 150b.

Approximate concurrently, chopper blade 165 of chopper folding member 156 shifts downward to contact chopper-folding position 152 of signature 150b and further moves downwards.

That folds signature 150b into two at chopper-folding position 152 along transfer direction 130 to be made into signature 150c (see FIG. 6(c)), which has the length W/2 and the width L/2 in transfer direction 130.

One type of chopper folding is wrap folding which folds an object at a chopper-folding position slightly deviated from the center. Signature 150d obtained by wrap folding has, as shown in FIG. 6(d), a displacement of the edges of the folded sides as much as wrap amount R.

Signature 150d has the length (W−R)/2+R and the width L/2 in transfer direction 130.

Signatures 150c and 150d are pressed by a pair of folding roller 169, thereby being folded and are transferred in transfer direction 130 (downwards).

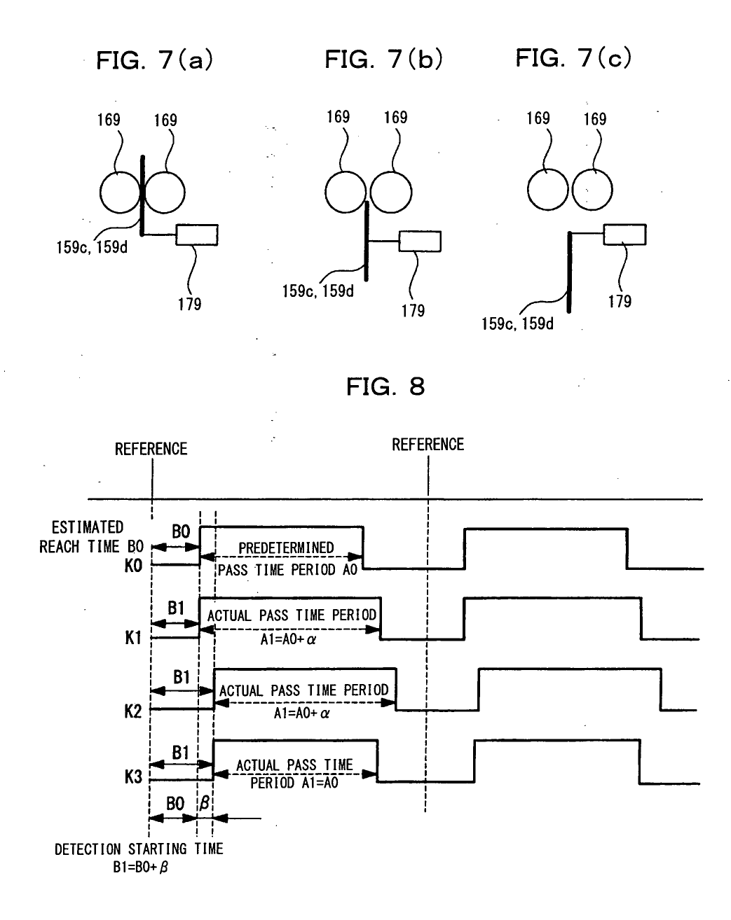

At that time, when signatures 150c and 150d reach sheet detecting unit 179 as shown in FIG. 7(a), sheet detecting unit 179 emits “on” signals. As long as signatures 150c and 150d are passing through 179 as shown in FIG. 7(b), sheet detecting unit 179 continuously emits “on” signals. Upon signatures 150c and 150d passing through sheet detecting unit 179, sheet detecting unit 179 turns off.

Signatures 150c and 150d ejected from folding rollers 169 fall between contiguous blades of cross-folding impeller 149, which times to rotate, are carried downwards in conjunction with rotation of cross-folding impeller 149 and finally fall on delivery conveyer 153.

Signatures 150c and 150d successively fall on delivery conveyer 153 and are transferred by delivery conveyer 153 as described above, and consequently transferred in a state of being piled like roof tiles.

For example, minute variations in quality and/or thickness of stopper members 19, a variation in surface states of web 119 and folding rollers 169, or adherence of paper dusts cause the friction between folding rollers 169 and signatures 150c and 150d to vary and signatures 150c and 150d may slip between folding rollers 169.

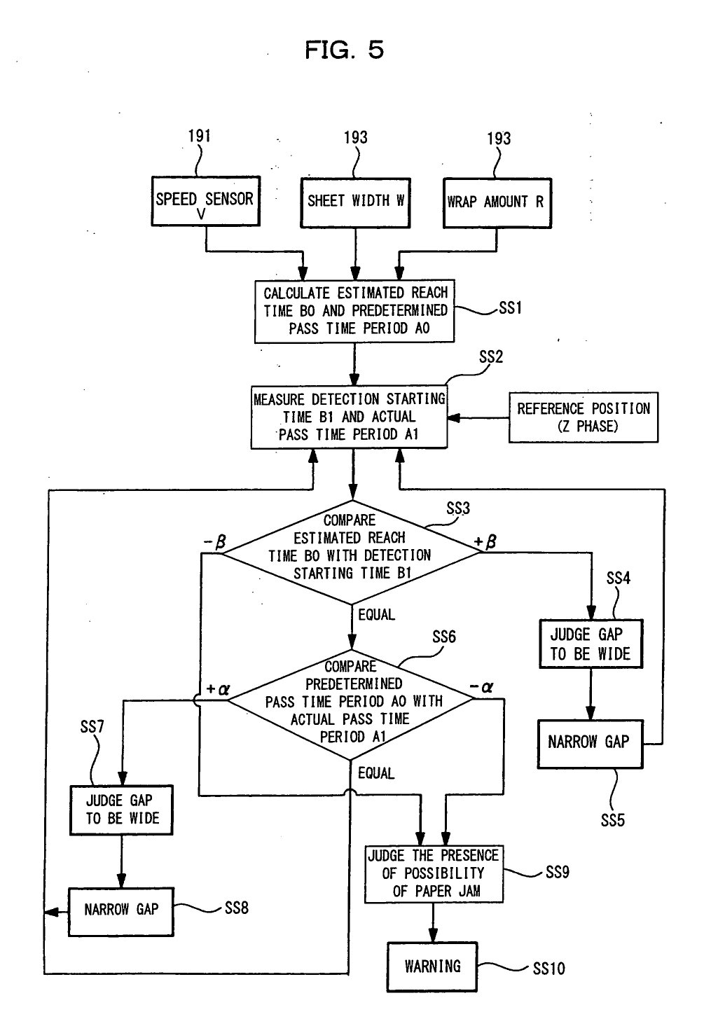

The solution to the problem will now be described on the basis of FIG. 5.

In gap control unit 163, predetermined time calculator 183 calculates the length of signature 150c or 150d in transfer direction 130 with reference to the width W and the wrap amount R of web 119 input via input means 193, and divides the calculated length by the print speed detected by speed sensor 191 to obtain predetermined pass time period A0 of signature 150c and/or 150d.

Speed sensor 191 detects the rotation speed of driving motor which drives rotary press 101 and uses the detected speed as a speed signal, or attaches an encoder to the rotation axis of folding cylinder 141 and uses, for example, an FV converter to convert a rotational frequency of the Z phase into a speed, which is regarded as a speed signal.

In addition, the phase on which web 119 is cut by folding cylinder 141 and gripper cylinder 143 is set to be the reference position of the Z phase, and calculates estimated reach time B0 at which the edge of signature 150c or 150d reach the position of sheet detecting unit 179 using reference to the distance between the cutting position and the position of sheet detecting unit 179 (step SS1).

The predetermined pass time period A0 and the estimated reach time B0 calculated are sent to memory 185.

Next, time detector 181 detects the time period during which sheet detecting unit 179 emits a detection signal, i.e., the unit is “on” to calculate the actual pass time period A1 for which signature 150c or 150d takes to pass through sheet detecting unit 179.

Further, time detector 181 detects detection starting time B1 at which sheet detecting unit 179 detects signature 150c or 150d from the reference position of the Z phase (step SS2).

The actual pass time period A1 and the detection starting time B1 calculated are sent to memory 185 and judging section 187.

Judging section 187 compares estimated reach time B0 sent from memory 185 with detection starting time B1 sent from time detector 181 (step SS3).

As cases K2 and K3 shown in FIG. 8, if detection starting time B1 is time β later than estimated reach time B0, judging section 187 judges the gap between a pair of folding rollers 169 to be wide (step SS4) and instructs designating section 189 to narrow the gap (step SS5).

On the basis of the instruction, designating section 189 sends motor 177 a control signal to narrow the gap. Motor 177 operates responsive to the control signal and narrows the gap between the pair of folding rollers 169.

For the sake of assurance of control stability, judging section 187 functions motor 177 not for each individual signature 150c or 150d, but observes a predetermined number of signatures 150c and 150d, e.g., 10 signatures, passing through and adjusts the average value of the observed deviations. In addition, judging section 187 determines an adjustment amount for each time to be a predetermined amount.

Alternatively, a predetermined-dead zone may be set. For example, if the deviation is within 10%, the deviation may not be adjusted.

If detection starting time B1 is equal to estimated reach time B0, judging section 187 compares estimated passing time period A0 sent from memory 185 with actual pass time period A1 sent from time detector 181 (step SS6).

As cases K1 and K2 in FIG. 8, actual pass time period A1 is time period α longer than estimated passing time period A0, judging section 187 judges that the gap between a pair of folding rollers 169 is wide and instructs designating section 189 to narrow the gap (step SS8). A wide gap between folding rollers 169 weakens force to nip signatures 150c and 150d, and causes slip between folding rollers and signatures 150c and 150d. Consequently, it takes time period α longer to pass web 119 through between folding rollers as the above cases.

On the basis of the instruction, designating section 189 sends motor 177 a control signal to narrow the gap. Motor 177 operates responsive to the control signal and narrows the gap between a pair of folding rollers 169.

Also in this case, for the sake of assurance of control stability, judging section 187 functions motor 177 not for each individual signature 150c or 150d, but observes a predetermined number of signatures 150c and 150d, e.g., 10 signatures, passing through and adjusts the average value of the observed deviations. In addition, judging section 187 determines an adjustment amount for each time to be a predetermined amount.

Alternatively, a predetermined dead zone may be set. For example, if the deviation is 10%, the deviation may not be adjusted.

If detection starting time 31 is time 13 earlier than estimated reach time B0 in step SS3 or if actual pass time period A1 is time period α shorter than estimated passing time period A0 in step SS6, judging section 187 judges that there is possibility of a paper jam (step SS9) and warns against the possibility by means of display or voice (step SS10).

As described above, since, for signatures 150c and 150d, actual detection starting time B1 is compared with estimated reach time B0 and/or actual pass time period A1 is compared with predetermined pass time period A0 and the gap between a pair of folding rollers 169 is adjusted on the basis of the comparison results, it is possible to finely adjust the gap between folding rollers 169, considering an actual transfer state of signatures 150c and 150d by folding rollers 169 when printing is being performed, such that the transfer timing of signatures 150c and 150d is substantially constant. With this adjustment, signatures 150c and 150d are sent to cross-folding impeller 149 at predetermined timings, which makes it possible to prevent signatures 150c and 150d from colliding with a blade and flying away or to prevent two or more signatures 150c and 150d from coming into a single gap between blades to disturb the ejection, and to avoid other problems.

Therefore signatures 150c and 150d can be ejected in a predetermined manner to avoid decline in product quality and in operation efficiency.

Further, judging section 187 can selectively replace predetermined pass time period A0 and estimated reach time period B0 of comparison object with actual pass time period A1 and detection starting time B1 which concern a particular time point and which have been sent to memory 185. This is realized by selective designation, i.e., switching by an operator.

At such a particular time point, control is stabilized and the operator judges that the ejecting state of signatures 150c and 150d is fine. Actual pass time period A1 and detection starting time B1 at a particular time point can be regarded as predetermined pass time period A0 and estimated reach time B0, respectively.

That can further improve the transfer timing of printed web.

Further, since the phase on which web 119 is cut is determined to be the reference position of the Z phase, it is possible to use signals to control operations such as cut-off control.

With this configuration, there is no need to install new signal emitting means, reducing costs.

The long di stance between the cut-off position of web 119 and the position of sheet detecting unit 179 may cause a delay of detection starting time B1 due to the gap between a pair of folding rollers 169.

As a solution to this problem, there is arranged a sheet detecting unit (second detector) 199 having the same function as sheet detecting unit 179 at immediately upstream of the pair of folding rollers 169, and the phase at a detection starting time by sheet detecting unit 199 may be regarded as the reference position of the Z phase, i.e., a L5 predetermined reference position.

With this configuration, since only folding rollers 169 are arranged between sheet detecting units 179 and 199, a variation in speed of signature 150c and 150d is caused only by the friction between the signatures and folding rollers 169 but not by variation in transfer speed at the remaining part of the transfer path of signatures 150c and 150d.

As a consequence, the gap between the pair of folding rollers 169 can be properly adjusted.

The present invention should by no means be limited to the foregoing embodiments, and various modifications can be suggested without departing from the spirit of the present invention.

1. An adjusting apparatus for a gap between folding rollers of a printing press, comprising:
a gap adjusting mechanism, mounted to the printing press, for adjusting the gap between a pair of the folding rollers which presses and fold a signature formed by cutting one or more printed sheets;
a detecting unit for detecting transfer state information relative to actually passing the printed sheets through the gap between the pair of the folding rollers; and
a controller for controlling said gap adjusting mechanism so that the gap between the folding rollers corresponds to the transfer state information detected by said detecting unit.

2. An adjusting apparatus according to claim 1, further comprising an actuator for actuating said gap adjusting mechanism, wherein:
said detecting unit includes a sensor for measuring the gap between the pair of the folding rollers;
said controller controls operation of the printing press, and controls operation of said actuator based on the result of the measuring by said sensor such that the gap becomes an optimum value; and
if a print condition is changed, said controller controls said actuator such that the gap is an initial distance according to the print condition and functions the printing press at a low speed before normal operation of the printing press, determines the optimum value of the gap based on a measurement value of the gap obtained in the measuring by said sensor as the signature passes through the gap between the pair of the folding rollers, and controls the operation of said actuator such that the gap becomes the optimum value.

3. An adjusting apparatus according to claim 2, wherein said folding rollers are chopper rollers which press and fold the signature chopper-folded.

4. An adjusting apparatus according to claim 2, wherein said folding rollers are folding-down dragging rollers which press and fold the signature cross-folded by a folding blade of a folding cylinder.

5. An adjusting apparatus according to claim 2, wherein said controller functions the printing press at a low speed and performs the measuring of the gap between the pair of the folding rollers through which a predetermined number of the signatures are passing on a predetermined number of the signatures, and determines the optimum value on the basis of an average value of a number of measurement values obtained by the measuring.

6. An adjusting apparatus according to claim 2, wherein said controller determines a value obtained by subtracting a minute value from the measurement value to be the optimum value of the gap.

7. An adjusting apparatus according to claim 2, wherein said gap adjustment mechanism includes:
a force applying member for applying a force to the pair of the folding rollers in such a direction that widening of the gap between the pair of the folding rollers is restricted;
a movable stopper member being opposed to said force applying member and being in contact with a supporting member in such a direction that narrowing of the gap between the pair of the folding rollers is restricted; and
a position adjusting member for adjusting a position of said movable stopper member,
said actuator driving said position adjusting member.

8. An adjusting apparatus according to claim 7, wherein:
said movable stopper member has a first stopper member being in contact with one of the pair of the folding rollers and a second stopper member being in contact with the other of the pair of the folding rollers, said first stopper member and said second stopper member being formed with screw threads of the opposite directions from each other,
said position adjusting member is a screw axis formed with external threads each threadedly engaging with one of the screw threads of said first stopper member and said second stopper member; and
said first stopper member and said second stopper member are not rotated by rotation of the screw axis such that said first stopper member and said second stopper member come close to each other or depart from each other according to the rotation of the screw axis.

9. An adjusting apparatus according to claim 2, wherein said gap adjusting mechanism, said actuator and said sensor are dedicated to each of the folding rollers, and said controller controls the operation of said actuators based on the measurement value obtained by said sensors.

10. An adjusting apparatus according to claim 2, wherein the print condition includes at least one of a kind of the printed sheets, the number of pages or a folded state of the signature entering between the pair of the folding rollers, a state of ink transferring in the printing and a printing atmosphere.

11. An adjusting apparatus according to claim 1, wherein:
said detecting unit is a first detector arranged downstream of the pair of the folding rollers in relation to a transferring direction of the printed sheet and detects passage of the printed sheets; and
said controller compares an actual time required to pass the printed sheets obtained from a detection signal from said first detector with a predetermined time required to the pass, and adjusts the gap between the pair of the folding rollers on the basis of the result of the comparing.

12. An adjusting apparatus according to claim 11, wherein said controller selectively replaces the predetermined time period required to the pass with a particular one of the actual time required to the pass.

13. An adjusting apparatus according to claim 11, wherein said controller compares a detection starting time which is a period from a predetermined reference point to beginning detection of the printed sheets by the first detector and a predetermined reach time which is a period from a predetermined reference point to reaching of the printed sheets to said first detector, and adjusts the gap between the pair of the folding rollers on the basis of the result of the comparing.

14. An adjusting apparatus according to claim 13, wherein said controller selectively replaces the predetermined reach time with a particular one of the detection starting times.

15. An adjustment apparatus according to claim 13, wherein said controller uses a signal to cut the printed sheets in the cross direction as the predetermined reference point.

16. An adjustment apparatus according to claim 13, wherein said controller uses a detection starting signal issued from a second detector, which is arranged upstream of the pair of the folding rollers in relation to the transferring direction to detect passage of the printed sheets as the predetermined reference point.

17. A printing press comprising an adjustment apparatus for a gap between folding rollers defined in claim 1.

18. A method for adjusting a gap between folding rollers which press and fold a signature formed by cutting one or more printed sheets and which is included in a printing press including a gap adjusting apparatus to adjust the gap between the folding rollers for which printing press functions the gap adjusting apparatus according to a print condition such that the gap is adjusted to be an optimum value, comprising the steps of:
detecting transfer state information relative to actually passing the printed sheets through the gap between the pair of the folding rollers; and
controlling the gap adjusting mechanism so that the gap between the folding rollers corresponds to the transfer state information detected in said step of detecting.

19. A method for adjusting a gap between folding rollers according to claim 18 wherein:
the gap adjusting apparatus includes a gap adjusting mechanism for adjusting the gap between the pair of the folding rollers and an actuator for actuating the gap adjusting mechanism; and
said method further comprises the steps of
functioning the actuator such that the gap is an initial distance associated with the print condition,
measuring a distance of the gap between the pair of the folding rollers through which the printed sheets are passing while the printing press is operating at a low speed, the distance serving as the transfer state information,
determining the optimum value of the gap on the basis of a measurement value of the gap obtained in said step of measuring, and
controlling the actuator to function such that the gap becomes the optimum value determined in said step of determining.

20. A method for adjusting a gap between folding rollers according to claim 18, wherein said step of controlling comprises the sub-steps of:
measuring a pass time period of the printed sheet at a position downstream of the folding rollers in a direction of transferring the printed sheet; and
adjusting the gap between the pair of folding rollers on the basis of a result of comparison of the pass time period measured in said sub-step of measuring with a predetermined pass time period.

21. A method for adjusting a gap between folding rollers according to claim 20, wherein said step of adjusting the gap between the folding rollers is based on comparison of a detection starting time at the position downstream of the folding rollers from a predetermined reference point with a predetermined reach time at the position downstream of the folding rollers from a predetermined reference point.

22. A method for adjusting a gap between folding rollers of a printing press performed by an adjusting apparatus defined in claim 2, in which method, if a print condition is modified, the controller functions the actuator such that the gap is adjusted to the optimum value before a normal operation of the printing press, comprising the step of:
functioning the actuator such that the gap comes to be an initial distance associated with the print condition;
measuring the gap through which the signature is passing while the printing press is operating at a low speed;
determining the optimum value based on a measurement value obtained in step of measuring; and
functioning the actuator such that the gap comes to be the optimum value determined in said step of determining.

23. A method for adjusting a gap between folding rollers according to claim 19, further comprising the step of temporarily halting the printing press after completion of said step of measuring.
